(19) United States
(12) Patent Application Publication
(10) Pub. No.: US 2009/0290134 A1
(43) Pub. Date: Nov. 26, 2009

(54) EXPOSURE METHOD

(76) Inventors: Chiang-Lin Shih, Taipei Hsien (TW); Kuo-Yao Cho, Taichung County (TW)

Correspondence Address: NORTH AMERICA INTELLECTUAL PROPERTY CORPORATION, P.O. BOX 506, MERRIFIELD, VA, 22116, US

(21) Appl. No.: 12/188,218

(22) Filed: Aug. 8, 2008

(30) Foreign Application Priority Data
May 26, 2008 (TW) 097119346

(51) Int. Cl. G03B 27/52

(52) U.S. Cl. 355/30

(57) ABSTRACT

A method for exposure is provided to avoid a rise in temperature of a lens set. First, a light beam passes through a first light-receiving region of the lens set to expose a pattern on a substrate, and the first light-receiving region has a rise in temperature. Thereafter, the first light-receiving region is moved away. Afterwards, the light beam passes through a second light-receiving region of the lens set so that the first light-receiving region has a drop in temperature.

### BACKGROUND OF THE INVENTION

1. Field of the Invention

The present invention relates to an exposure method. In particular, the present invention relates to an exposure method which avoids image distortion problems caused by lens heating effects.

2. Description of the Prior Art

Exposure techniques play an essential role in the semiconductor industry because advanced exposure techniques make the pre-determined patterns on the reticles precisely transfer onto the substrate. The specification of the exposure system determines the critical dimension of the pattern feature. In the exposure system, the light source itself is the most basic factor that determines the critical dimension of the pattern feature. The shorter the wavelength of the light source is, usually the shorter the critical dimension of the pattern feature will be. With the help of certain optical auxiliary devices, such as off axis illumination (OAI) in the lens system, the critical dimension of the pattern feature may be further reduced.

Such optical auxiliary devices may improve the capabilities of the exposure instruments or enhance the precision or the sharpness of the images transferred from the reticles. Take the off axis illumination (OAI) for example, it is not to expose the entire field but to scan the patterns back and forth. Because only a part of the lens is used to scan the patterns, it is less likely affected by the defect of the lens.

However, the light is a form of the energy. The shorter the wavelength is, the higher the energy of the light will be. When the light passes through the projection optical system, the lenses in the projection optical system more or less absorb the energy of the light and generate heat. The heat induces physical property variations of the lenses and therefore changes the imaging path of the light so that the exposed images are distorted. In particular, only certain parts of the lenses are used in the exposure process in the off axis illumination (OAI), which makes the image asymmetric distortion even worse and therefore jeopardizes the precision or the sharpness of the images transferred from the reticles.

Accordingly, a novel method for exposure is needed in order to avoid exposure image distortion problem caused by lens heating due to uneven intensity profile or uneven intensity distribution on the pupil plane when the light beam passes through an asymmetric aperture, such as a dipole aperture.

### SUMMARY OF THE INVENTION

The present invention therefore provides a novel exposure method in order to avoid image distortion problem caused by lens heating due to uneven intensity profile or uneven intensity distribution of the lenses in the projection optical system after a period of time after the light beam passes through the projection optical system via an aperture of asymmetric diaphragms.

The present invention therefore provides an exposure method. First, a substrate is ready for the transfer of a pattern, and a light and a projection optical system are provided for allowing the light to pass through and transferring the pattern onto the substrate. At least a first light-receiving region corresponding to a first pattern and a second light-receiving region corresponding to a second pattern are provided in the optical projection system. The light beam passes through the first light-receiving region so that the first pattern is exposed on the substrate. The light beam passes through the second light-receiving region so that the second pattern is exposed on the substrate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-2 illustrate a preferred embodiment of the novel method for exposure of the present invention.

FIG. 3 illustrates the lens set of the novel method for exposure of the present invention.

### DETAILED DESCRIPTION

The present invention provides a novel method for exposure in order to avoid the problem of exposure image distortion caused by asymmetric lens heating to ensure the patterns to be precisely and correctly transferred from the reticle to the wafer during exposure process.

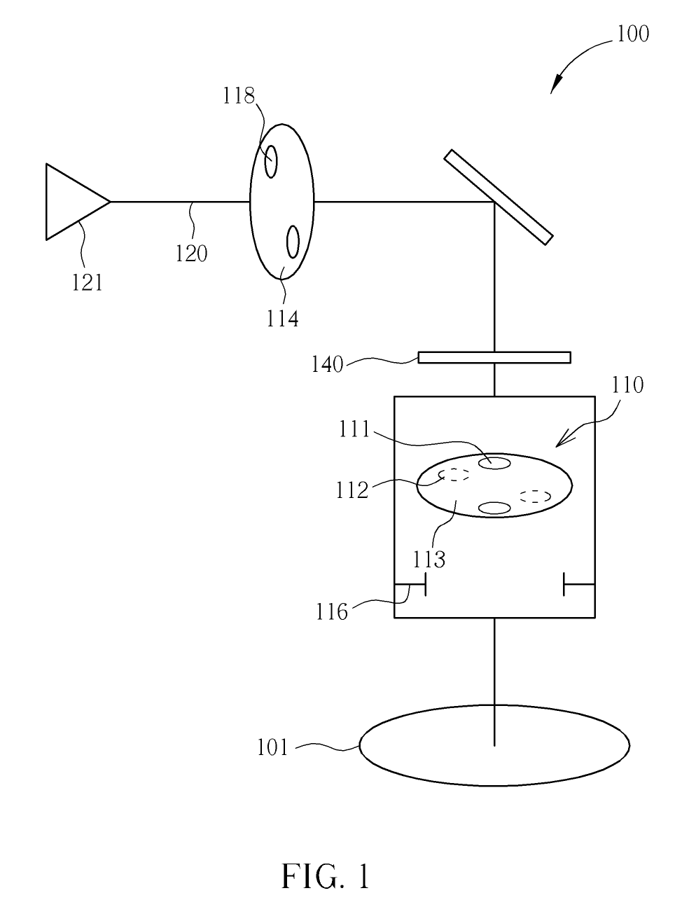

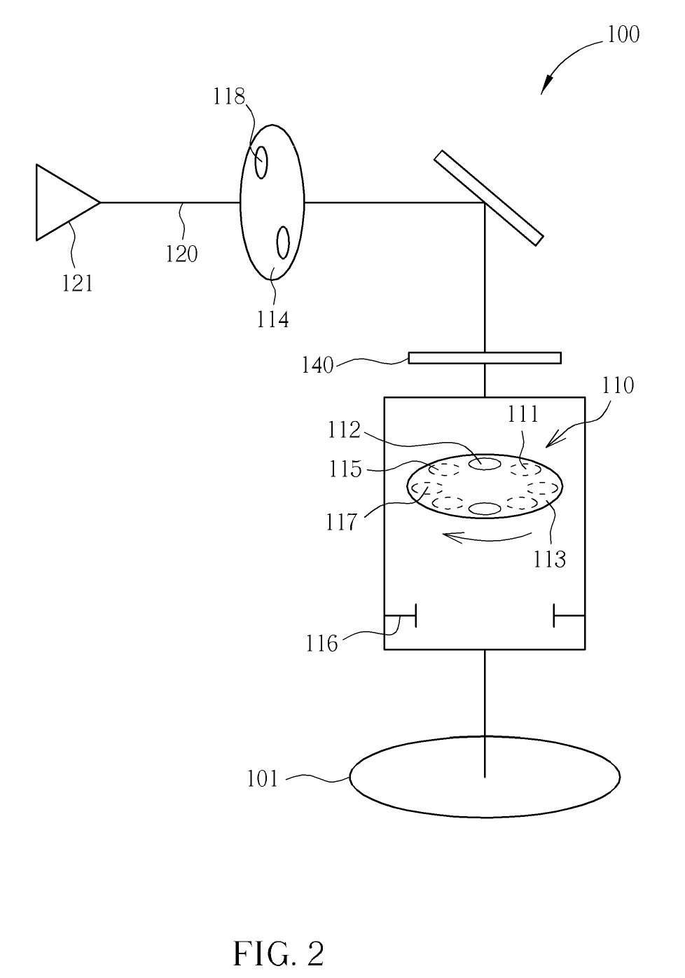

FIGS. 1-2 illustrate a preferred embodiment of the novel method for exposure of the present invention. For simplicity, the illustrations of FIGS. 1-2 are simplified and only the essential elements are illustrated. First, as shown in FIG. 1, the exposure system 100 includes a light source 121, an aperture 114, a reticle 140 (or a photomask), a projection optical system 110, a pupil plane 116 and a substrate 101. The light beam 120 generated form the light source 121 passes through the aperture 114 and the projection optical system 110 to transfer a pre-determined pattern (not shown) onto the substrate 101. The pupil plane 116 is located in the projection optical system 110 and below the lens 112.

The substrate may be any objective, such as a wafer, a color filter . . . etc, with a pre-determined pattern thereon and is ready for pattern transform.

The projection optical system 110 is for imaging the pre-determined pattern on the reticle 140, and may include multiple lenses. Only the lens 113 is described here for illustration purpose. The projection optical system 110 may include multiple regions for the light beam 120 to pass therethrough. The region(s) which the light beam passes through depends on the opening(s) 118 on the aperture 114 and corresponds to the lens 113 in the projection optical system 110. The intensity distribution is determined by the image(s) on the pupil plane 116. Accordingly, when an asymmetric aperture is used, the light-receiving region(s) on the lens 113 is also asymmetric, and therefore the lens 113 is affected irregularly by the heat so generated during the passing of the light beam such that heating effect to the lens 113 is formed. The light beam 120 may be an ordinary exposure light source, such as a light originated form off axis illumination (OAI).

For example, the asymmetric aperture 114 used here is a dipole aperture. The light beam 120 transfers the pre-determined pattern onto the substrate 101 by means of an imaging path, for instance, the opening 118 on the dipole aperture 114, an element with the pre-determined pattern, i.e. the reticle 140 in this example, the projection optical system 110 and the substrate 101. When the light beam 120 passes through the lens 113 of the projection optical system 110, the lens 113 provides with a first light-receiving region 111 to allow the light beam to pass therethrough, so that a first pattern (on the reticle 140) corresponding to the first light-receiving region 111 is exposed on the substrate 101. The first pattern may be any pattern, such as an active area pattern or a gate pattern to be transferred or defined on the substrate 101. Because the light beam 120 has energy, the temperature of the first light-receiving region 111 raises when the light beam 120 passes through the first light-receiving region 111 of the lens 113. When the temperature of the first light-receiving region 111 on the lens 130 is substantially raised, the lens heating effect induces uneven intensity distribution, and then affects the image on the pupil plane 116, accordingly, the exposed image of the first pattern is distorted. In order to maintain the quality of the exposed image of the first pattern, a novel method for exposure is rendered. The lens 113 provides a various light-receiving regions to allow the light beam 120 to pass without changing the above-mentioned imaging path before the image is distorted due to lens heating effect.

Accordingly, without changing the previously-mentioned imaging path that the light beam 120 passes, the projection optical system 110, in other words, the lens 113 provides various light-receiving regions to allow the light beam 120 to pass therethrough. The light-receiving position, for example the first light-receiving region 111, in the lens 113 may be changed by batch or continuously process. The method for changing the position of the first light-receiving region 111 in the lens 113 may be made by horizontally rotating the lens 113 clockwisely or counter-clockwisely. By adjusting the lens 113 to make the first light-receiving region 111 completely leave the original light-receiving position, another light-receiving position, such as a second light-receiving region 112 is therefore provided to maintain the same imaging path as the first light-receiving region 111 to allow the light beam to pass through and to avoid the problem of image distortion.

Preferably, during the time changing the first light-receiving region 111 in the lens 113 to the second light-receiving region 112, the light beam 120 is prevented from passing through the projection optical system 110. In addition, so long as the image quality of the first pattern is still acceptable, the light beam 120 may pass through the first light-receiving region 111 for several times before the first light-receiving region 111 in the lens 113 is changed to the second light-receiving region 112. The continuous process is that every time after the light beam passes through the first light-receiving region 111 of the lens 113, the first light-receiving region 111 is changed to the second light-receiving region 112 so that every time the light receiving region for the light beam is different. That is, during the change from the first light-receiving region 111 to the second light-receiving region 112, the light beam 120 passes through different light-receiving regions independent from one another. Arrangement of the first light-receiving region 111 and the second light-receiving region 112 is for illustration purpose only and may vary according to different requirements. The number of the light-receiving regions depends on the light-receiving area of the lens 113. For example, the lens 113 may further include a third light-receiving region 115 and a forth light-receiving region 117 . . . etc., as shown in FIG. 2.

Afterward the light beam 120 is provided again to pass through the second light-receiving region 112 so that a second pattern (not shown) is transferred to the surface of the substrate 101. Hence the current light-receiving position is not the first light-receiving region 111 anymore but the second light-receiving region 112 instead. Preferably, the first light-receiving region 111 and the second light-receiving region 112 do not overlap with each other at all. Since the light beam 120 does not pass through the first light-receiving region 111 any more, the temperature of the first light-receiving region 111 may readily drop so that the physical properties of the first light-receiving region 111 of the lens 113 may be back to normal.

The second pattern may be any pattern, such as an active area pattern or a gate pattern which is required to be transferred or defined on the substrate 101. The second pattern may be the same as or different from the first pattern.

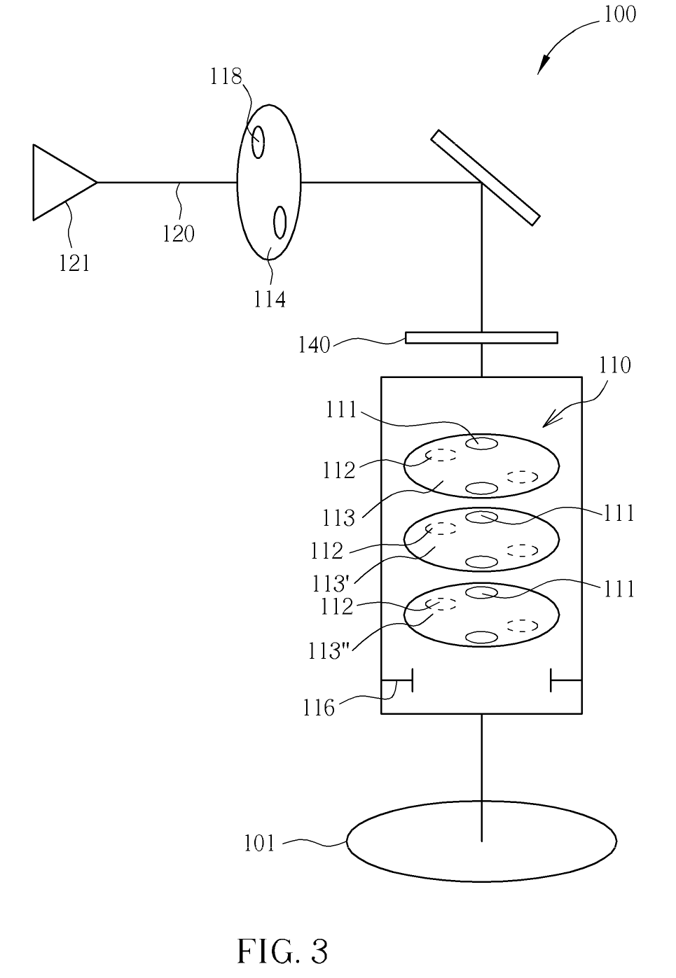

In other preferred embodiments, the projection optical system 110 may have multiple lenses, which is called lens set for short, as shown in FIG. 3. The multiple lenses 13, 113′, 113″ have optical symmetry with each other. The light-receiving positions in the lens set correspond to each other and may be moved away by directly horizontally rotating the projection optical system 110 without changing the afore-defined imaging path which the light beam 120 passes through the lens set. Each lens in the lens set may be rotated clockwisely or counter-clockwisely. The rotary direction of each lens may be the same or different.

In the novel method for the exposure of the present invention, the light beam passes through the lens of the projection optical system from the aperture of asymmetric openings, so that the light-receiving regions are asymmetric. The original light-receiving region is moved away before lens heating effects is occurred to keep an acceptable image quality. The light beam passes through other regions as the new light-receiving region to avoid the same region being heated too much due to prolonged light-receiving. The present invention solves the problem of distorted images and ensures a good exposure quality.

Those skilled in the art will readily observe that numerous modifications and alterations of the device and method may be made while retaining the teachings of the invention.

What is claimed is:

1. An exposure method, comprising:
providing a substrate to receive at least a first pattern and a second pattern thereon, a light beam and a projection optical system which allows said light beam to pass through and transfers said first and second pattern onto said substrate;
providing at least a first light-receiving region and a second light-receiving region in said optical projection system, wherein said first light-receiving region corresponds to said first pattern and said second light-receiving region corresponds to said second pattern;
transferring said first pattern on said substrate by passing said light beam through said first light-receiving region; and
transferring said second pattern on said substrate by passing said light beam through said second light-receiving region.

2. The method for exposure of claim 1 further comprising an asymmetric aperture situated in front of said projection optical system such that said light beam passes through said first light-receiving region of said optical projection system via said asymmetric aperture.

3. The method for exposure of claim 2, wherein said asymmetric aperture is a dipole aperture.

4. The method for exposure of claim 1, wherein said projection optical system comprises a lens.

5. The method for exposure of claim 1, wherein said optical projection system comprises multiple lenses.

6. The method for exposure of claim 4, wherein said first light-receiving region is formed on said lens.

7. The method for exposure of claim 5, wherein said first light-receiving region is formed on said multiple lenses.

8. The method for exposure of claim 1, wherein said first pattern is the same as said second pattern.

9. The method for exposure of claim 1 further comprising:
changing said first light-receiving region to said second light-receiving region by rotating said optical projection system so that the location of said first light-receiving region becomes that of said second light-receiving region.

10. The method for exposure of claim 9, wherein the changing step is carried out by a batch process.

11. The method for exposure of claim 9, wherein changing step is carried out by a continuous process.

12. The method for exposure of claim 9, wherein said rotating step is processed clockwise.

13. The method for exposure of claim 9, wherein said rotating step is processed counter-clockwise.

14. The method for exposure of claim 1, wherein said first light-receiving region is free of overlapping with said second light-receiving region.

15. The method for exposure of claim 4, wherein said first light-receiving region is free of overlapping with said second light-receiving region.

16. The method for exposure of claim 5, wherein said first light-receiving region is free of overlapping with said second light-receiving region.

17. The method for exposure of claim 5, wherein said light beam is prevented from passing through said projection optical system when changing said first light-receiving region to said second light-receiving region.
